(19) United States
(12) Patent Application Publication
(10) Pub. No.: US 2013/0173749 A1
(43) Pub. Date: Jul. 4, 2013

(54) METHODS AND DEVICES FOR PROVIDING DIGITAL CONTENT

(71) Applicants: PEKING UNIVERSITY FOUNDER GROUP CO., LTD., Beijing (CN); Founder Mobile Media Technology (Beijing) Co., Ltd., Beijing (CN)

(72) Inventors: Changgiao WANG, Beijing (CN); Hongbo Che, Beijing (CN); Yao Duan, Beijing (CN)

(73) Assignees: Founder Mobile Media Technology (Beijing) Co., Ltd., Beijing (CN); PEKING UNIVERSITY FOUNDER GROUP CO., LTD., Beijing (CN)

(21) Appl. No.: 13/731,727

(22) Filed: Dec. 31, 2012

(30) Foreign Application Priority Data
Dec. 30, 2011 (CN) 201110457857.2

(51) Int. Cl. H04L 29/08

(52) U.S. Cl. CPC H04L 67/02
USPC 709/217

(57) ABSTRACT

A method for providing a digital content, including: determining, by a first device, a digital content to be synchronized in progress upon determining that a synchronization trigger condition is satisfied; obtaining, by the first device, current browsing progress information of the digital content; and transmitting, by the first device, a content identifier of the digital content and the current browsing progress information to a second device, to instruct the second device to store the current browsing progress information corresponding to the digital content identified by the content identifier.

### RELATED APPLICATIONS

This application claims the benefit of priority from Chinese Patent Application No. 201110457857.2, filed Dec. 30, 2011, the entire contents of which are incorporated herein by reference.

### FIELD

The present invention relates to methods and devices for providing digital content.

### BACKGROUND

In daily life, a user may prefer to read an electronic document on a terminal device, but such a situation may arise where a user reads an electronic document on a first terminal device, and when reading the content of Chapter N, the user may not further read the electronic document on the first terminal device due to, e.g., a lack of power in the first terminal device. As a result, the user has to read the electronic document on a second terminal device, and at this time, even if the electronic document is also stored in the second terminal device, when the user opens the electronic document on the second terminal device, the second terminal device may only provide the user with the content from the starting chapter of the electronic document, and the user may not read the content of Chapter N directly but has to go through the starting chapter to Chapter N, thus resulting in a lack of flexibility in providing the user with the electronic document.

In addition, the above issue may also arise when the user browses other types of digital content. For example, for a digital content of a video, a user may watch the video on a first terminal device until the M^{th} minute, and then the user may not further watch the video on the first terminal device due to a lack of power in the first terminal device, and may have to watch the video on a second terminal device. At this time, even if the video is also stored in the second terminal device, when the user opens the video on the second terminal device, the second terminal device may only provide the user with the content from the starting section of the video, and the user may not be able to watch the content of the M^{th} minute directly but has to go through the content of the starting section to the M^{th} minute for watching.

Thus, traditional devices may lack flexibility in providing a user with a digital content.

### SUMMARY

According to a first aspect of the present disclosure, a method for providing a digital content includes: determining, by a first device, a digital content to be synchronized in progress upon determining that a synchronization trigger condition is satisfied; obtaining, by the first device, current browsing progress information of the digital content; and transmitting, by the first device, a content identifier of the digital content and the current browsing progress information to a second device, to instruct the second device to store the current browsing progress information corresponding to the digital content identified by the content identifier.

According to a second aspect of the present disclosure, a first device includes: a synchronization trigger condition determining unit configured to determine that a synchronization trigger condition is satisfied; a digital content determining unit coupled to the synchronization trigger condition determining unit and configured to determine a digital content to be synchronized in progress when the synchronization trigger condition determining unit determines that the synchronization trigger condition is satisfied; a browsing progress information obtaining unit coupled to the digital content determining unit and configured to obtain current browsing progress information of the digital content; and a browsing progress information transmitting unit coupled to the browsing progress information obtaining unit and configured to transmit a content identifier of the digital content and the current browsing progress information to a second device, to instruct the second device to store the current browsing progress information corresponding to the digital content identified by the content identifier.

According to a third aspect of the present disclosure, a method for providing a digital content includes: receiving a user request including a content identifier of a digital content; searching for the digital content identified by the content identifier in the user request and browsing progress information corresponding to the digital content; and providing a found digital content based on a found browsing progress information.

It is to be understood that both the foregoing general description and the following detailed description are exemplary and explanatory only and are not restrictive of the invention, as claimed.

### BRIEF DESCRIPTION OF THE DRAWINGS

FIG. 1 shows a flowchart of a progress synchronizing method for providing a digital content, according to an exemplary embodiment.

FIG. 2 illustrates a method for a first terminal device to transmit relevant information of a digital content to a second terminal device in an e-mail, according to an exemplary embodiment.

FIG. 3 illustrates a method for a first terminal device to transmit relevant information of a digital content to a second terminal device in a short message or a multimedia message, according to an exemplary embodiment.

FIG. 4 illustrates a block diagram of a first terminal device, according to an exemplary embodiment.

FIG. 5 illustrates a block diagram of a second terminal device, according to an exemplary embodiment.

FIG. 6 shows a flowchart of a method for providing a digital content, according to an exemplary embodiment.

FIG. 7 illustrates a block diagram of a terminal device, according to an exemplary embodiment.

### DETAILED DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments consistent with the present invention do not represent all implementations consistent with the invention. Instead, they are merely examples of systems and methods consistent with aspects related to the invention as recited in the appended claims.

In exemplary embodiments, one or more units disclosed in this disclosure may be implemented via one or more processors executing software programs for performing functionalities. In some embodiments, one or more of the disclosed units are implemented via one or more hardware units executing firmware for performing functionalities. In some embodiments, one or more of the disclosed units include storage media for storing data, or software or firmware programs executed by the units.

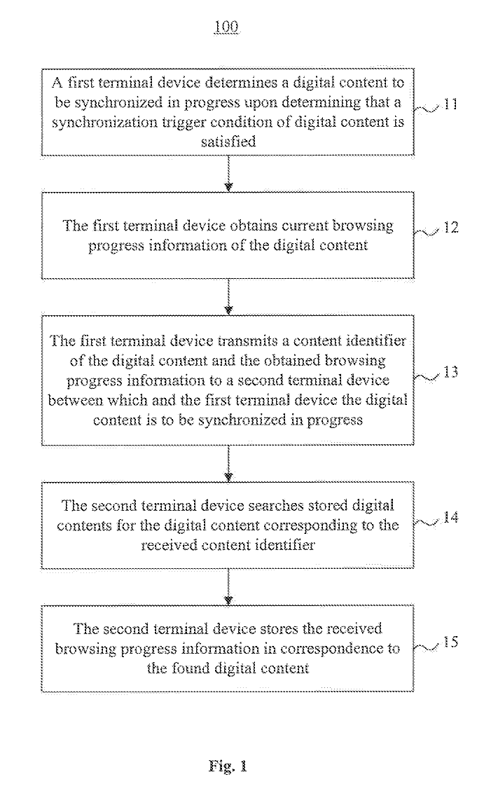

FIG. 1 shows a flowchart of a progress synchronizing method 100 for providing a digital content, according to an exemplary embodiment. Referring to FIG. 1, the method 100 may include the following steps.

In step 11, a first terminal device determines a digital content to be synchronized in progress upon determining that a synchronization trigger condition of digital content is satisfied.

In exemplary embodiments, the digital content may be, but is not limited to, an electronic document, a video, or an audio. When the digital content is an electronic document, a browsing progress may be a reading progress at which the electronic document is read. For example, when a user reads Section 6, Chapter 5 of the electronic document, a corresponding reading progress is Section 6, Chapter 5. When the digital content is a video, a browsing progress may be a watching progress at which the video is watched. For example, when a user watches the 25^{th} minute of the video, a corresponding watch progress is the 25^{th} minute. When the digital content is an audio, a browsing progress is a listening progress at which the audio is listened to. For example, when a user listens to the 15^{th} minute of the audio, a corresponding listening progress is the 15^{th} minute.

In exemplary embodiments, the synchronization trigger condition of digital content may be, but is not limited to, the following:

(1) That a progress synchronization request by the user is received while providing the user with a digital content. For example, when the user browses the digital content on the first terminal device, if the user may not further browse the digital content on the first terminal device due to some reason, e.g., a lack of power in the first terminal device, and has to browse the digital content on a second terminal device, the user may click on a progress synchronization button on the first terminal device to transmit to the second terminal device a progress synchronization request for synchronizing a browsing progress of the user on the first terminal device;

(2) That a specified synchronization point of time is reached while providing the user with a digital content. For example, while the user browses the digital content on the first terminal device, reading/playing software periodically performs progress synchronization, that is, the reading/playing software presets an interval of time and performs progress synchronization at each interval of time, e.g., each time a specified synchronization point of time is reached, starting from the point of time when the user opens the digital content; and

(3) That a digital content closure request of the user is received while providing the user with a digital content. For example, while the user browses the digital content on the first terminal device, if the user closes the digital content, that is, the user transmits a digital content closure request to the first terminal device, the first terminal device is triggered to perform a progress synchronization process.

In exemplary embodiments, for the above three synchronization trigger conditions, the first terminal device may determine the digital content currently provided to the user as the digital content to be synchronized in progress. In addition, the synchronization trigger condition of digital content may also be the following:

(4) That a reading/playing software closure request of the user is received. For example, while the user browses the digital content on the first terminal device, if the user closes the reading/playing software, that is, the user transmits a reading/playing software closure request to the first terminal device, the first terminal device is triggered to perform a progress synchronization process; and

(5) That a device closure request of the user is received. For example, while the user browses the digital content on the first terminal device, if the user closes the first terminal device, that is, the user transmits a device closure request to the first terminal device, the first terminal device is triggered to perform a progress synchronization process.

In exemplary embodiments, for the above two synchronization trigger conditions, the first terminal device may determine digital contents provided to the user in a period of time between a point of time of last progress synchronization and a current point of time as the digital contents to be synchronized in progress. For example, the first terminal device provides the user with three digital contents, i.e., digital content 1, digital content 2, and digital content 3, respectively in a period of time between a current point of time and a point of time of last progress synchronization. As a result, the first terminal devices determines these three digital contents as the digital contents to be synchronized in progress.

In step 12, current browsing progress information of the digital content is obtained. If there are a plurality of digital contents to be synchronized in progress, the first terminal device obtains current browsing progress information of each of the digital contents.

In step 13, the first terminal device transmits a content identifier of the digital content and the obtained browsing progress information to a second terminal device between which and the first terminal device the digital content is to be synchronized in progress.

In exemplary embodiments, a device identifier of the second terminal device may be preset on the first terminal device, and subsequently the first terminal device may transmit the content identifier of the digital content and the obtained browsing progress information directly to the second terminal device corresponding to the preset device identifier. Further, the first terminal device may firstly output prompt information after obtaining the current browsing progress information of the digital content, to ask the user to enter the device identifier of the second terminal device between which and the first terminal device the digital content is to be synchronized in progress. The user may enter the device identifier of the second terminal device in response to the prompt information and then click and confirm. As a result, the first terminal device obtains the device identifier entered by the user and transmits the content identifier of the digital content and the obtained browsing progress information to the second terminal device corresponding to the obtained device identifier.

In exemplary embodiments, the first terminal device may transmit the content identifier and the browsing progress information of the digital content to the second terminal device in, e.g., data or an e-mail. The data includes a short message, a multimedia message, etc.

In exemplary embodiments, the short message, the multimedia message, or the e-mail transmitted from the first terminal device to the second terminal device may include a specific identifier to indicate to the second terminal device that the short message, the multimedia message or the e-mail is for progress synchronization. The second terminal device may intercept the short message, the multimedia message, or the e-mail with the specific identifier for processing upon reception.

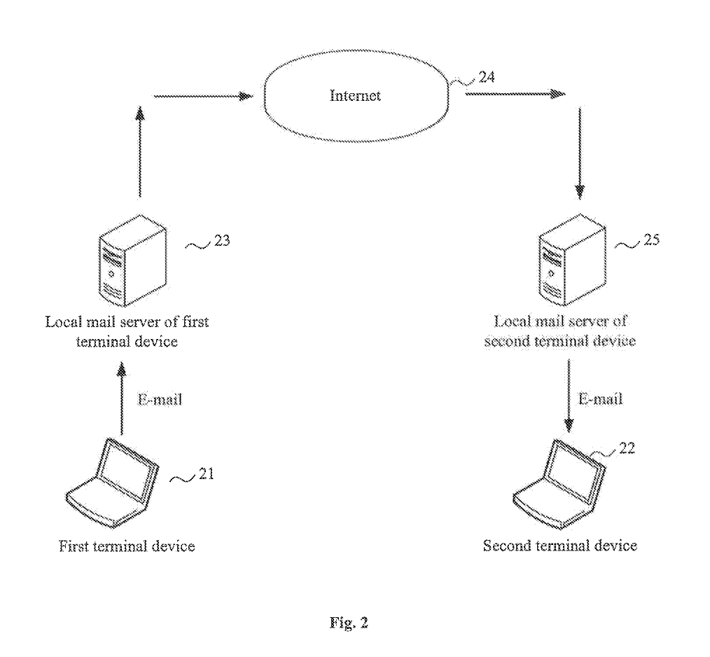

If the first terminal device transmits the relevant information, i.e., the content identifier and the browsing progress information, of the digital content to the second terminal device in an e-mail, the device identifier of the second terminal device may be an e-mail account ID bound with the second terminal device. FIG. 2 illustrates a method for the first terminal device, e.g., a first laptop 21, to transmit relevant information of the digital content to the second terminal device, e.g., a second laptop 22, in an e-mail, according to an exemplary embodiment. Referring to FIG. 2, the first laptop 21 transmits the relevant information, i.e., the content identifier and the browsing progress information, of the digital content to the second laptop 22 in an e-mail through a local mail server 23 of the first laptop 21, an Internet 24, and a local mail server 25 of the second laptop 22. In the illustrated embodiment, the device identifier of the second laptop 22 is an e-mail account ID bound with the second laptop 22.

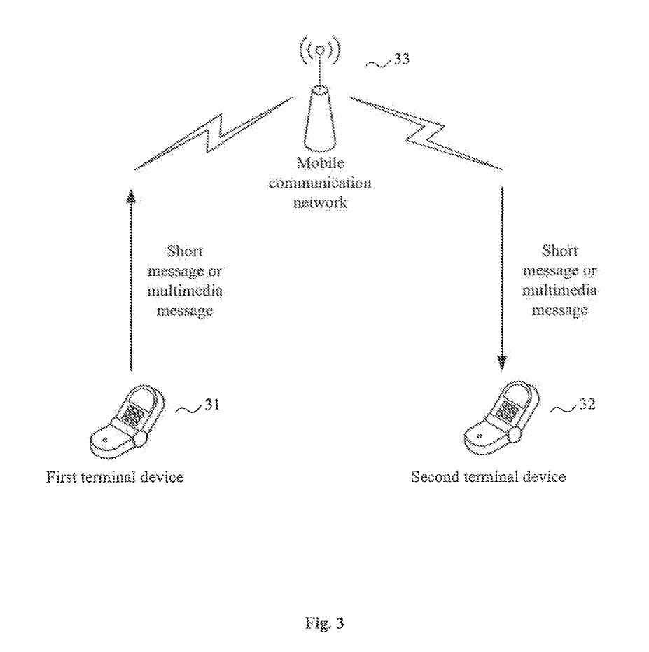

If the first terminal device transmits the relevant information, i.e., the content identifier and the browsing progress information, of the digital content to the second terminal device in a short message or a multimedia message, the device identifier of the second terminal device may be a mobile phone number bound with the second terminal device. FIG. 3 illustrates a method for the first terminal device, e.g., a first mobile phone 31, to transmit the relevant information of the digital content to the second terminal device, e.g., a second mobile phone 32, in a short message or a multimedia message, according to an exemplary embodiment. Referring to FIG. 3, the first mobile phone 31 transmits the relevant information, i.e., the content identifier and the browsing progress information, of the digital content to the second mobile phone 32 in a short message or a multimedia message through a mobile communication network 33. In the illustrated embodiment, the device identifier of the second mobile phone 32 is a phone number of the second mobile phone 32.

Referring back to FIG. 1, in step 14, the second terminal device searches stored digital contents for the digital content corresponding to the received content identifier. For example, the second terminal device may have numerous digital contents stored therein and may firstly check whether the digital content is stored locally to find the digital content, upon reception of the content identifier and the browsing progress information transmitted from the first terminal device.

In step 15, the second terminal device stores the received browsing progress information corresponding to the found digital content.

If the digital content is an electronic document, the user may make notes while reading the electronic document on the first terminal device. In exemplary embodiments, the first terminal device may obtain the current browsing progress information of the digital content and also note information from the user for the digital content. The first terminal device may then transmit the content identifier of the digital content, the obtained browsing progress information, and the note information to the second terminal device. The second terminal device may store the received browsing progress information and note information corresponding to the found digital content.

In exemplary embodiments, the first terminal device may transmit the digital content to the second terminal device in an e-mail or a multimedia message, by encrypting the digital content to be transmitted and then including the digital content in an attachment of the e-mail or an attachment of the multimedia message transmitted to the second terminal device. The second terminal device may decrypt and then store the received digital content.

In exemplary embodiments, the first and second terminal devices may each be, but not be limited to, a desktop computer, a notebook computer, a handset device, an electronic book reading device, etc.

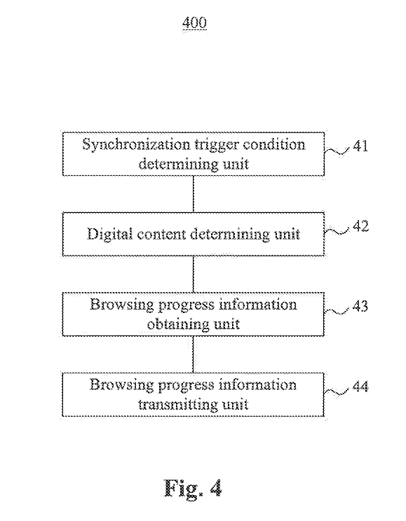

FIG. 4 illustrates a block diagram of the first terminal device, referred to herein as a device 400, according to an exemplary embodiment. Referring to FIG. 4, the device 400 may include a synchronization trigger condition determining unit 41, a digital content determining unit 42, a browsing progress information obtaining unit 43, and a browsing progress information transmitting unit 44.

In exemplary embodiments, the synchronization trigger condition determining unit 41 is configured to determine that a synchronization trigger condition of digital content is satisfied. The digital content determining unit 42 is configured to determine a digital content to be synchronized in progress when the synchronization trigger condition determining unit 41 determines that the synchronization trigger condition of digital content is satisfied. The browsing progress information obtaining unit 43 is configured to obtain current browsing progress information of the digital content. The browsing progress information transmitting unit 44 is configured to transmit a content identifier of the digital content and the current browsing progress information obtained by the browsing progress information Obtaining unit 43 to the second terminal device between which and the device 400 the digital content is to be synchronized in progress, to instruct the second terminal device to store the browsing progress information corresponding to the digital content identified by the content identifier.

In one exemplary embodiment, the digital content is an electronic document, and the device 400 further include a note information obtaining unit (not shown) configured to obtain note information made by a user on the digital content. The browsing progress information transmitting unit 44 is further configured to transmit the content identifier of the digital content, the current browsing progress information obtained by the browsing progress information obtaining unit 43, and the note information obtained by the note information obtaining unit to the second terminal device, and to instruct the second terminal device to store the browsing progress information and the note information corresponding to the digital content identified by the content identifier.

In exemplary embodiments, the synchronization trigger condition of digital content may be that a progress synchronization request of a user is received while providing the user with a digital content, that a specified synchronization point of time is reached while providing a user with a digital content, or that a digital content closure request of a user is received while providing the user with a digital content, as described above. The digital content determining unit 42 is further configured to determine the digital content currently provided to the user as the digital content to be synchronized in progress.

In exemplary embodiments, the synchronization trigger condition of digital content may be that a reading/playing software closure request is received, or that a device closure request is received, as described above. The closure request can be from the user or from the device itself caused by reasons, such as a lack of power. The digital content to be synchronized can be digital content that is playing at the closure time. Alternatively, the digital content determining unit 42 is further configured to determine a digital content provided to the user in a period of time between a point of time of last progress synchronization and a current point of time as the digital content to be synchronized in progress.

In exemplary embodiments, the browsing progress information transmitting unit 44 may further include a prompt information outputting sub-unit (not shown) configured tri output prompt information to ask a user to enter a device identifier of the second terminal device, a device identifier obtaining sub-unit (not shown) configured to obtain the device identifier entered by the user, and a browsing progress information transmitting sub-unit (not shown) configured to transmit the content identifier of the digital content and the browsing progress information obtained by the browsing progress information obtaining unit 43 to the second terminal device identified by the device identifier obtained by the device identifier obtaining sub-unit.

In exemplary embodiments, the browsing progress information transmitting unit 44 is further configured to transmit, in data or an e-mail, the content identifier of the digital content and the browsing progress information obtained by the browsing progress information obtaining unit 43 to the second terminal device.

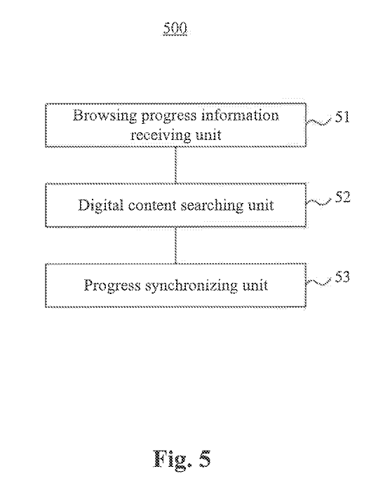

FIG. 5 illustrates a block diagram of the second terminal device, referred to herein as a device 500, according to an exemplary embodiment. Referring to FIG. 5, the device 500 may include a browsing progress information receiving unit 51, a digital content searching unit 52, and a progress synchronizing unit 53.

In exemplary embodiments, the browsing progress information receiving unit 51 is configured to receive the content identifier of the digital content and browsing progress information corresponding to the digital content transmitted from the first terminal device. The digital content searching unit 52 is configured to search stored digital contents to find the digital content corresponding to the received content identifier. The progress synchronizing unit 53 is configured to store the browsing progress information received by the browsing progress information receiving unit 51 corresponding to the digital content found by the digital content searching unit 52.

In one exemplary embodiment, the digital content is an electronic document, and the browsing progress information receiving unit 51 is further configured to receive note information on the digital content in addition to the content identifier of the digital content and the browsing progress information corresponding to the digital content, all of which are transmitted from the first terminal device. The progress synchronizing unit 53 is further configured to store the received browsing progress information and the received note information corresponding to the digital content found by the digital content searching unit 52.

In exemplary embodiments, the browsing progress information receiving unit 51 is further configured to receive the content identifier of the digital content and the browsing progress information corresponding to the digital content, both of which is transmitted from the first terminal device, in data or an e-mail.

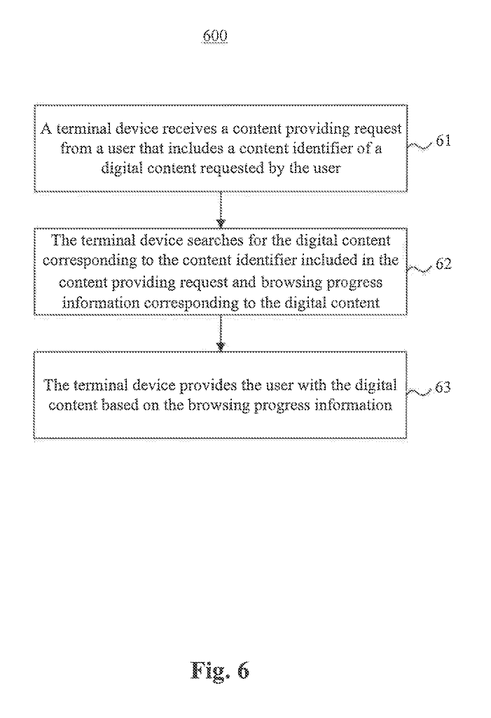

FIG. 6 shows a flowchart of a method 600 for providing a digital content, according to an exemplary embodiment. Referring to FIG. 6, the method 600 may include the following steps.

In step 61, a terminal device receives a content providing request from a user that includes a content identifier of a digital content requested by the user. In the illustrated embodiment, the digital content may be, but is not limited to, an electronic document, a video, or an audio. The terminal device may be, but is not limited to, a desktop computer, a notebook computer, a handset device, an electronic book reading device, etc.

In step 62, the terminal device searches for the digital content corresponding to the content identifier included in the content providing request and browsing progress information corresponding to the digital content.

When the digital content is an electronic document, a browsing progress is a reading progress at which the electronic document is read. When the digital content is a video, a browsing progress is a watching progress at which the video is watched. When the digital content is an audio, a browsing progress is a listening progress at which the audio is listened to.

In the illustrated embodiment, the terminal device has stored therein a plurality of digital contents and browsing progress information of the respective digital contents. The terminal device may search for both the digital content and the browsing progress information corresponding to the digital content identified by the content identifier included in the content providing request.

In exemplary embodiments, the terminal device may also store note information on the digital content during progress synchronization. The terminal device may search for the note information on the digital content in addition to the digital content and the browsing progress information.

In step 63, the terminal device provides the user with the found digital content based on the found browsing progress information. The terminal device may not need to provide the user with the digital content from a starting section of the digital content. For example, if the digital content is an electronic document with a reading progress of Section 6, Chapter 5, the terminal device may provide the user directly with the content of Section 6, Chapter 5 of the electronic document after finding the electronic document and the corresponding reading progress information. Also for example, if the digital content is a video with a watching progress of the 25^{th} minute, the terminal device may provide the user directly with the content of the 25^{th} minute of the video after finding the video and the corresponding watching progress information. Further for example, if the digital content is an audio with a listening progress of the 15^{th} minute, the terminal device may provide the user directly with the content of the 15^{th} minute of the audio after finding the audio and the corresponding watching listening information.

In exemplary embodiments, the terminal device may also store note information on the digital content during progress synchronization, and may provide the user with the note information in addition to the digital content based on the browsing progress information.

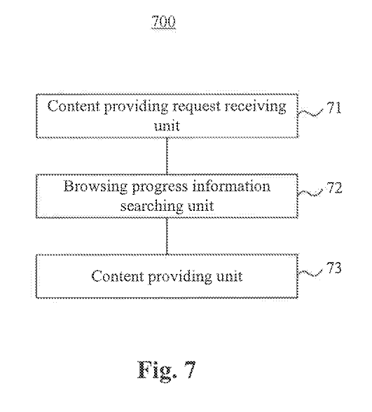

FIG. 7 illustrates a block diagram of the terminal device, referred to herein as a device 700, according to an exemplary embodiment. Referring to FIG. 7, the device 700 may include a content providing request receiving unit 71, a browsing progress information searching unit 72, and a content providing unit 73.

In exemplary embodiments, the content providing request receiving unit 71 is configured to receive a content providing request from a user that includes a content identifier of a digital content requested by the user. The browsing progress information searching unit 72 is configured to search for the digital content corresponding to the content identifier included in the content providing request and browsing progress information corresponding to the digital content. The content providing unit 73 is configured to provide the user with the found digital content found based on the found browsing progress information.

In exemplary embodiments, the browsing progress information searching unit 72 is further configured to search for note information on the digital content in addition to the digital content and the browsing progress information. The content providing unit 73 is further configured to provide the user with the note information in addition to the digital content based on the browsing progress information.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only; with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims

1. A method for providing a digital content, comprising:
determining, by a first device, a digital content to be synchronized in progress upon determining that a synchronization trigger condition is satisfied;
obtaining, by the first device, current browsing progress information of the digital content; and
transmitting, by the first device, a content identifier of the digital content and the current browsing progress information to a second device, to instruct the second device to store the current browsing progress information corresponding to the digital content identified by the content identifier.

2. The method according to claim 1, wherein the digital content comprises at least one of an electronic document, a video, or an audio.

3. The method according to claim 1, wherein when the digital content is an electronic document, the method further comprises:
obtaining, by the first device, user note information on the digital content; and
transmitting, by the first device, the user note information in addition to the content identifier of the digital content and the current browsing progress information to the second device, to instruct the second device to store the current browsing progress information and the user note information corresponding to the digital content.

4. The method according to claim 1, wherein when the synchronization trigger condition is:
that a progress synchronization request is received while providing a user with a digital content; or
that a specified synchronization point of time is reached while providing a user with a digital content; or
that a digital content closure request is received while providing a user with a digital content,
determining the digital content by the first device further comprises:
determining the digital content currently provided to the user as the digital content to be synchronized in progress.

5. The method according to claim 1, wherein when the synchronization trigger condition is:
that a software closure request is received; or
that a device closure request is received,
determining the digital content by the first device further comprises:
determining a digital content provided to a user in a period of time between a point of time of last progress synchronization and a current point of time as the digital content to be synchronized in progress.

6. The method according to claim 1, wherein transmitting the content identifier and the current browsing progress information further comprises:
outputting prompt information to ask a user to enter a device identifier of the second device;
obtaining the device identifier entered by the user; and
transmitting the content identifier of the digital content and the current browsing progress information to the second device identified by the obtained device identifier.

7. The method according to claim 1, wherein transmitting the content identifier and the current browsing progress information further comprises:
transmitting data or an e-mail including the content identifier of the digital content and the current browsing progress information to the second device.

8. A first device, comprising:
a synchronization trigger condition determining unit configured to determine that a synchronization trigger condition is satisfied;
a digital content determining unit coupled to the synchronization trigger condition determining unit and configured to determine a digital content to be synchronized in progress when the synchronization trigger condition determining unit determines that the synchronization trigger condition is satisfied;
a browsing progress information obtaining unit coupled to the digital content determining unit and configured to obtain current browsing progress information of the digital content; and
a browsing progress information transmitting unit coupled to the browsing progress information obtaining unit and configured to transmit a content identifier of the digital content and the current browsing progress information to a second device, to instruct the second device to store the current browsing progress information corresponding to the digital content identified by the content identifier.

9. The first device according to claim 8, wherein the digital content is an electronic document, and the first device further comprises:
a note information obtaining unit configured to obtain user note information on the digital content; and
the browsing progress information transmitting unit configured to transmit the user note information in addition to the content identifier of the digital content and the current browsing progress information, to instruct the second device to store the current browsing progress information and the user note information corresponding to the digital content.

10. The first device according to claim 8, wherein when the synchronization trigger condition is:
that a progress synchronization request is received while providing a user with a digital content; or
that a specified synchronization point of time is reached while providing a user with a digital content; or
that a digital content closure request is received while providing a user with a digital content,
the digital content determining unit is further configured to determine the digital content currently provided to the user as the digital content to be synchronized in progress.

11. The first device according to claim 8, wherein when the synchronization trigger condition is:
that a software closure request is received; or
that a device closure request is received,
the digital content determining unit is further configured to determine a digital content provided to a user in a period of time between a point of time of last progress synchronization and a current point of time as the digital content to be synchronized in progress.

12. The first device according to claim 8, wherein the browsing progress information transmitting unit further comprises:
a prompt information outputting sub-unit configured to output prompt information to ask a user to enter a device identifier of the second device;
a device identifier obtaining sub-unit configured to obtain the device identifier entered by the user; and
a browsing progress information transmitting sub-unit configured to transmit the content identifier of the digital content and the current browsing progress information to the second device identified by the device identifier obtained by the device identifier obtaining sub-unit.

13. The first device according to claim 8, wherein the browsing progress information transmitting unit is further configured to transmit data or an e-mail including the content identifier of the digital content and the current browsing progress information to the second device.

14. A method for a device to provide a digital content, comprising:
receiving a user request including a content identifier of a digital content;
searching for the digital content identified by the content identifier in the user request and browsing progress information corresponding to the digital content; and
providing a found digital content based on a found browsing progress information.

15. The method according to claim 14, wherein the searching and the providing further comprise:
searching for user note information on the digital content in addition to the digital content and the browsing progress information; and
providing the user note information in addition to the found digital content based on the found browsing progress information.
